(19) United States
(12) Patent Application Publication
(10) Pub. No.: US 2004/0195990 A1
(43) Pub. Date: Oct. 7, 2004

(54) Robust current loop controller for servo system

(75) Inventors: Chin-Shiong Tsai, Yongkang City (TW); Chien-Da Chen, Yongkang City (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC, Taoyuan Hsien (TW)

(21) Appl. No.: 10/791,127

(22) Filed: Mar. 2, 2004

(30) Foreign Application Priority Data
Mar. 3, 2003 (TW) 092104454

(51) Int. Cl. G05F 1/10; G05B 11/36

(52) U.S. Cl. 318/650

(57) ABSTRACT

A robust current loop controller for a servo system is provided. The robust current loop controller includes a model reference controller and a current controller. The model reference controller generates a velocity command signal from a current command reference signal of the servo system and generates a current command signal through comparing the velocity command signal with a feedback velocity command signal of the servo system. The current controller generates a control signal from the current command signal, the current command reference signal and a current feedback signal in order to drive the servo system.

### FIELD OF THE INVENTION

The present invention relates to a current loop controller. In particular, the present invention relates to a robust current loop controller for a servo system.

### BACKGROUND OF THE INVENTION

Please refer to FIG. 1, which is a block diagram of a typical servo system. A typical servo system 100 includes the motor system 101, the current controller 102, and the velocity controller 103. The transfer function of the motor system 101 includes a coil transfer function, Gₐ(S)=1/(Ls+R), and a mechanism transfer function, G_{J}(s)=1/(Ls+R), where L denotes the winding inductance, R denotes the winding resistance, J denotes the equivalent rotor inertia of the motor system, and B denotes the equivalent damping coefficient of the motor system. The transfer function of the current controller 102 is G_{c}(s). The transfer function of the velocity controller 103 is Gₛ(s). ω(s) denotes the rotation rate of the motor, i_{f}(s) denotes the feedback current, iₐ(s) denotes the current command of the motor and vᵣ(s) denotes the velocity command of the motor.

In the typical servo control system 100, the current and the velocity of the motor system 101 is controlled by the current controller 102 and the velocity controller 103, respectively. Generally, since the coil parameters L, R of the motor system 101 are only influenced by the temperature, the change of the coil parameters would be small if the temperature is not too high. Also, the current loop of the prior servo system is approximately constant under 500 Hz. However, the mechanism parameters J, B are changed with different loads.

Please refer to FIG. 2, which is a Bode Plot diagram for the velocity open loop of the typical servo control system. As shown in FIG. 2, while the rotor inertia J increases, the Bode gain of the open loop (dB) decreases owing to considering that the velocity of the velocity controller is fixed. This enlarges the steady-state error and the active-state error of the whole servo system. Therefore, it is necessary to have an additional velocity controller with higher gain in order to meet the requirement of the servo control properties. In order to overcome this problem of the typical driver, the estimator is used for obtaining an inertia value, and then an appropriate velocity controller is provided. However, the solution is only suitable for which the inertia changes slow. For which the inertia changes fast, the solution will cause bad actions of the servo system.

### SUMMARY OF THE INVENTION

It is an object of the present invention to provide a robust current loop controller for a servo system. A model reference controller is provided for controlling a rotor inertia which is changed according to the load of the servo system to be approximate to the reference value of the rotor inertia of the motor.. The robust property is still provided by the current loop.

It is an further object of the present invention to provide a robust current loop controller for a servo system. A model reference controller is provided for inputting the difference in value beween the model output and the angular valocity of the rotor of the motor immediately to the current controller in order to resist the external interference of the servo system. The robust property against the external interference is provided by the current loop.

It is an further object of the present invention to provide a robust current loop controller for a servo system. When there is resonance in the servo system, a model reference controller is provided for inhibiting the resonance automatically.

In accordance with one aspect of the present invention, the current loop controller for the servo system of the present invention includes: a model reference controller generating a velocity command signal from a current command reference signal of the servo system and generating a current command signal through comparing the velocity command signal with a feedback velocity command signal of the servo system; and a current controller generating a control signal from the current command signal, the current command reference signal and a current feedback signal in order to drive the servo system.

Preferably, the servo system is an AC servo system.

Preferably, the servo system is a permanent magnet servo system.

Preferably, a transfer function of the model reference controller is Kₜ/(Jₘs+Bₘ), wherein Jₘ is a reference of a rotor inertia of a motor, Bₘ is a damping coefficient of a motor and Kₜ is a ratio.

Preferably, a rotor inertia control which is changed according to a load of the servo system is controlled by the model reference controller to be approximate to the reference of the rotor inertia of the motor.

Preferably, Jₘ and Bₘ of the transfer function, Kₜ/(Jₘs+Bₘ), are according to a default of a specification.

Preferably, the specification is a steady-state error of the servo system.

Preferably, the current command signal is generated by the model reference controller according to a difference between the velocity command signal and the feedback velocity command signal.

Preferably, the control signal is a voltage-controlled signal.

Preferably, the control signal is a current-controlled signal.

In accordance with another aspect of the present invention, the method for controlling a current loop in a servo system includes steps of: generating a velocity command signal from a current command reference signal of the servo system through a first operation; generating a current command signal through comparing the velocity command signal with a feedback velocity command signal of the servo system; and generating a control signal from the current command signal, the current command reference signal and a current feedback signal through a second operation in order to drive the servo system.

Preferably, the servo system is an AC servo system.

Preferably, the servo system is a permanent magnet servo system.

Preferably, a transfer function of the model reference controller is Kₜ/(Jₘs+Bₘ), wherein Jₘ is a reference of a rotor inertia of a motor, Bₘ is a damping coefficient of a motor and Kₜ is a ratio.

Preferably, a rotor inertia control which is changed according to a load of the servo system is controlled by the model reference controller to be approximate to the reference of the rotor inertia of the motor.

Preferably, the current command signal is generated by the model reference controller according to a difference between the velocity command signal and the feedback velocity command signal.

Preferably, the control signal is a voltage-controlled signal.

Preferably, the control signal is a current-controlled signal.

The foregoing and other features and advantages of the present invention will be more clearly understood through the following descriptions with reference to the drawings, wherein:

### BRIEF DESCRIPTION OF THE DRAWING

FIG. 1 is a block diagram of the typical servo system according to the prior art;

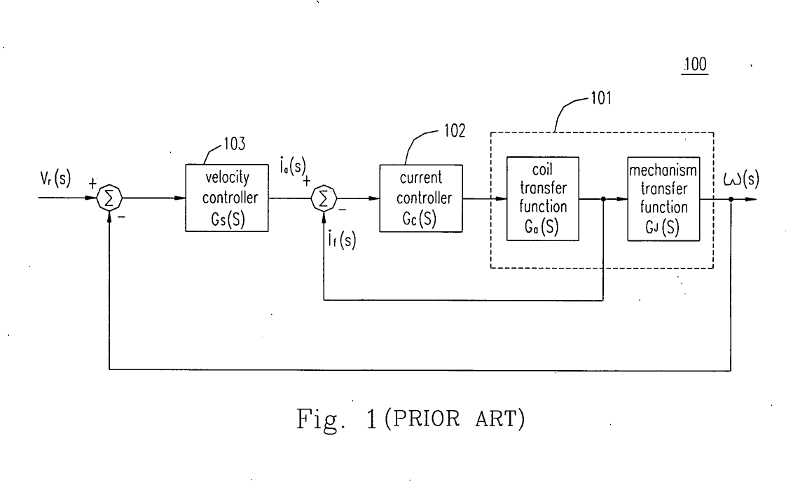

FIG. 2 is a Bode Plot diagram for the velocity open loop of the typical servo control system according to the prior art;

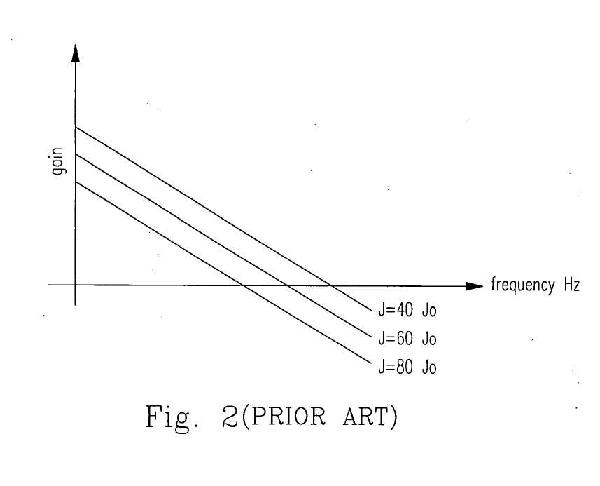

FIG. 3 is a block diagram illustrating the robust current loop controller for the servo system in accordance with a preferable embodiment of the present invention; and

FIG. 4 is a Bode Plot diagram for the velocity open loop of the robust current loop controller for the servo system in accordance with a preferable embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed

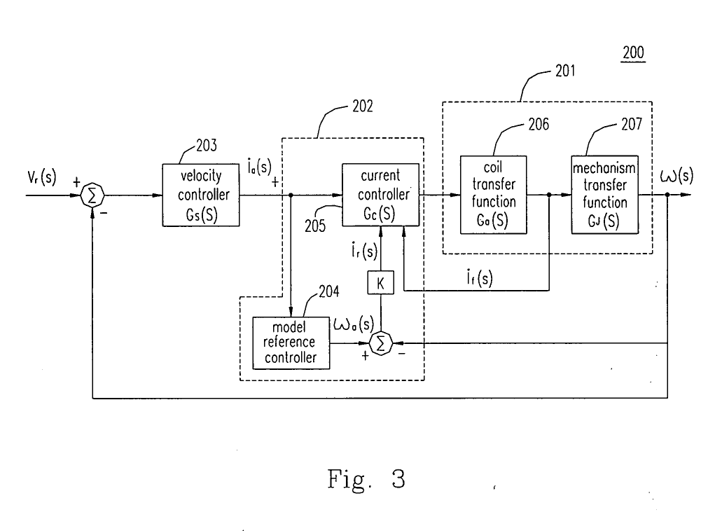

Please refer to FIG. 3, which is a block diagram illustrating the robust current loop controller for the servo system in accordance with a preferable embodiment of the present invention. As shown in FIG. 3, the current loop controller 202 includes the model reference controller 204 and the current controller 205. The velocity command signal ωₐ(s) is generated by the model reference controller 204 from the current command reference signal iₐ(s) of the servo system 200. The current command signal iᵣ(s) is generated through operating the difference in value between the velocity command signal ωₐ(s) and the feedback velocity command signal ω(s) of the servo system 200. The control signal is generated by the current controller 205 from the current command signal iᵣ(s), the current command reference signal iₐ(s) and the current feedback signal i_{f}(s) in order to drive the servo system 201. The servo system 201 can be represented by the coil transfer function 206 and the mechanism transfer function 207.

The servo system may be an AC servo system or a permanent magnet servo system. The transfer function of the model reference controller is Kₜ/(Jₘs+Bₘ), where Jₘ is the reference of the rotor inertia of the motor, Bₘ is the damping coefficient of the motor and Kₜ is the ratio. The rotor inertia control which is changed according to a load of the servo system is controlled by the model reference controller to be approximate to the reference of the rotor inertia of the motor.

Furthermore, the reference of the rotor inertia of the motor and the damping coefficient of the motor of the transfer function, Kₜ/(Jₘs+Bₘ), may be set according to the steady-state error, the active-state error or the response rate, etc. of the servo system.

Moreover, the current command reference signal iₐ(S) is generated by the velocity controller according to the difference between the velocity command signal ωₐ(s) and the velocity command reference signal vᵣ(s). The velocity command signal ωₐ(S) is the output rotation rate ω(s) of the servo system which the servo system 200 feedbacks to.

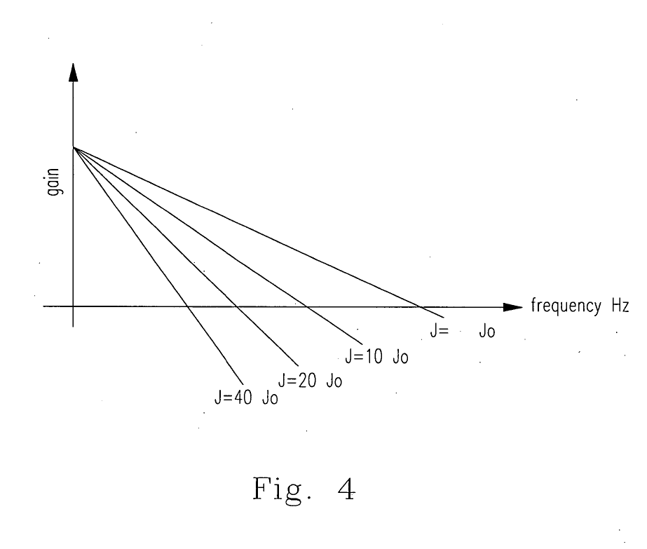

Please refer to FIG. 4, which is a Bode Plot diagram for the velocity open loop of the robust current loop controller for the servo system in accordance with a preferable embodiment of the present invention. Owing to the properties of the model reference theory, the low-frequency gain of the Bode Plot for the velocity open loop does not change with the change of the rotor inertia.

Therefore, the robust current loop controller in accordance with the present invention is provided for controlling the rotor inertia which is changed according to the load of the servo system to be approximate to the reference value of the rotor inertia of the motor, and the robust property is still provided by the current loop. Furthermore, it is possible to input the difference in value beween the model output and the angular valocity of the rotor of the motor immediately to the current controller in order to resist the external interference of the servo system, and the robust property against the external interference is provided by the current loop. Also, when there is resonance in the servo system, the model reference controller in accordance with the present invention is provided for inhibiting the resonance automatically. Hence, the present invention not only has a novelty and a progressive nature, but also has an industry utility.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claim is:

1. A current loop controller for a servo system comprising:
a model reference controller generating a velocity command signal from a current command reference signal of said servo system and generating a current command signal through comparing said velocity command signal with a feedback velocity command signal of said servo system; and
a current controller generating a control signal from said current command signal, said current command reference signal and a current feedback signal in order to drive said servo system.

2. A current loop controller according to claim 1 wherein said servo system is an AC servo system.

3. A current loop controller according to claim 1 wherein said servo system is a permanent magnet servo system.

4. A current loop controller according to claim 1 wherein a transfer function of said model reference controller is Kₜ/(Jₘs+Bₘ), wherein Jₘ is a reference of a rotor inertia of a motor, Bₘ is a damping coefficient of a motor and Kₜ is a ratio.

5. A current loop controller according to claim 4 wherein a rotor inertia control which is changed according to a load of said servo system is controlled by said model reference controller to be approximate to said reference of said rotor inertia of said motor.

6. A current loop controller according to claim 4 wherein Jm and Bm of said transfer function, Kₜ/(Jₘs+Bₘ), are according to a default of a specification.

7. A current loop controller according to claim 6 wherein said specification is a steady-state error of said servo system.

8. A current loop controller according to claim 1 wherein said current command signal is generated by said model reference controller according to a difference between said velocity command signal and said feedback velocity command signal.

9. A current loop controller according to claim 1 wherein said control signal is a voltage-controlled signal.

10. A current loop controller according to claim 1 wherein said control signal is a current-controlled signal.

11. A method for controlling a current loop in a servo system comprising steps of:
generating a velocity command signal from a current command reference signal of said servo system through a first operation;
generating a current command signal through comparing said velocity command signal with a feedback velocity command signal of said servo system; and
generating a control signal from said current command signal, said current command reference signal and a current feedback signal through a second operation in order to drive said servo system.

12. A method according to claim 11 wherein said servo system is an AC servo system.

13. A method according to claim 11 wherein said servo system is a permanent magnet servo system.

14. A current loop controller according to claim 11 wherein a transfer function of said model reference controller is Kₜ/(Jₘs+Bₘ), wherein Jₘ is a reference of a rotor inertia of a motor, Bₘ is a damping coefficient of a motor and Kₜ is a ratio.

15. A current loop controller according to claim 14 wherein a rotor inertia control which is changed according to a load of said servo system is controlled by said model reference controller to be approximate to said reference of said rotor inertia of said motor.

16. A current loop controller according to claim 11 wherein said current command signal is generated by said model reference controller according to a difference between said velocity command signal and said feedback velocity command signal.

17. A current loop controller according to claim 11 wherein said control signal is a voltage-controlled signal.

18. A current loop controller according to claim 11 wherein said control signal is a current-controlled signal.
